(19) United States
(12) Patent Application Publication
(10) Pub. No.: US 2003/0182086 A1
(43) Pub. Date: Sep. 25, 2003

(54) Method of process reconciliation for electronic service interaction

(76) Inventor: Giacomo Piccinelli, Bristol (GB)

Correspondence Address: HEWLETT-PACKARD COMPANY, Intellectual Property Administration, P.O. Box 272400, Fort Collins, CO, 80527-2400, US

(21) Appl. No.: 10/387,967

(22) Filed: Mar. 12, 2003

(30) Foreign Application Priority Data
Mar. 13, 2002 (GB) 0205874.1

(51) Int. Cl. G06F 11/30; G06F 15/00; G21C 17/00

(52) U.S. Cl. 702/186

(57) ABSTRACT

A method of testing compatibility of at least two electronic service interaction processes comprises:

running a first interaction process 32 of a first computing platform and a second interaction process 34 of a second computing platform in a process reconciler 30, in which each of the interaction processes is treated separately;

analysing input/output requirements for the first/second interaction process 32/34 for compatibility with the second/first interaction process 34/32; and

passing input/output data between the first computing platform and the second computing platform via said process reconciler 30, on detecting said compatibility.

### FIELD OF THE INVENTION

This invention relates to a method of process reconciliation for electronic service interaction.

### DESCRIPTION OF RELATED PRIOR ART

When electronic services are provided by separate parties it is well known that those separate parties will occasionally wish the services they provide to interact with each other, possibly in the roles of service provider and service consumer. In this situation both parties expect a specific interaction process to be enacted.

The two parties concerned will typically enter an agreement whereby each specifies what services are required or will be provided and how each party is to handle the interaction. The verification of compliance with a business level interaction protocol (service delivery process) is a problem well known, particularly for e-business applications.

Different solutions to this well known problem are already in place, but all are based on the idea that the business application (i.e. a computing environment or a computing platform of an organisation) has to verify the interaction process with its counterpart. As shown in FIG. 1 each of the parties is likely to have an internal structure consisting of a number of parts for example a finance department 10, a procurement department 12 and an administration department 14, all of which communicate with one another to form the first party's business application 16. The business application 16 of the first party has a communication portal 18 which communicates with a corresponding communication portal 20 of the second party's business application 22 which itself is made up of different parts 24, 26, 28. In prior art solutions each of the business applications 16 and 22 has to verify the interaction process with the other party. The interaction process is spread across the business application itself 16, 22 and as far as interaction is concerned the following procedure is used:

a) outgoing messages are sent as soon as they are ready, without further control. If they are rejected by the counterpart business application, some sort of contingency is activated;

b) incoming messages are accepted if they are compatible with the current state (i.e. current expectation of input) of the applications forming the business application and then they are processed. Otherwise they are discarded and some form of exception is raised.

Compliance is achieved, but this type of approach has two major drawbacks. It makes the design of business applications complex. It also focuses on fixing problems when detected, instead of proactively preventing problems.

### SUMMARY OF THE INVENTION

According to a first aspect of the invention a method of testing compatibility of at least two electronic service interaction processes comprises:

running a first interaction process of a first computing platform and a second interaction process of a second computing platform in a process reconciler, in which each of the interaction processes is treated separately;

analysing input/output requirements for the first/second interaction process for compatibility with the second/first interaction process; and

passing input/output data between the first computing platform and the second computing platform via said process reconciler, on detecting said compatibility.

The first and second interaction processes are preferably analysed for compatibility at substantially each stage where an output is given or an input is expected.

The first and second interaction processes are preferably run substantially simultaneously whilst compatibility is found. An exception may be raised if compatibility is not found.

The method advantageously tests compatibility between two interaction processes to a level of structural compatibility, rather than syntactical identity.

The analysis may include checking that at a given stage the expected output of one of the first and second interaction processes is the same as the expected input for the other of the first and second interaction processes.

The first and second interaction processes are preferably world-wide-web interaction processes.

The first and second interaction processes may be interaction processes for the sale/purchase of goods and/or services.

The process reconciler advantageously acts as an intermediary between the first and second computing platforms, which may be business applications. The process reconciler may permit each of the first and second computing platforms to use its own interaction process, but still interact with the other computing platform.

The process reconciler may be run by a third party independent from the first and second computing platforms. Alternatively, the process reconciler may be run by one of the first and second computing platforms.

The invention extends to a computer programmed to perform the method of the first aspect.

The invention extends to a process reconciler operable to perform the method of the first aspect. The process reconciler may be stored on a recordable medium.

The invention extends to a recordable medium bearing a program operable to perform the method of the first aspect.

All of the features disclosed herein may be combined with any aspect of the invention in any combination.

### BRIEF DESCRIPTION OF THE DRAWINGS

For a better understanding of the invention and to show how the same may be brought into effect, a specific embodiment will now be described, by way of example, and with reference to the accompanying drawings, in which:

FIG. 1 is a schematic diagram of a prior art system showing the internal arrangement of two business applications and the communication therebetween;

FIG. 2 is a schematic diagram showing the interaction between the two business applications shown in FIG. 1 but with the applications communicating via a process reconciler; and

FIG. 3 is a schematic flow diagram of a method of process reconciliation.

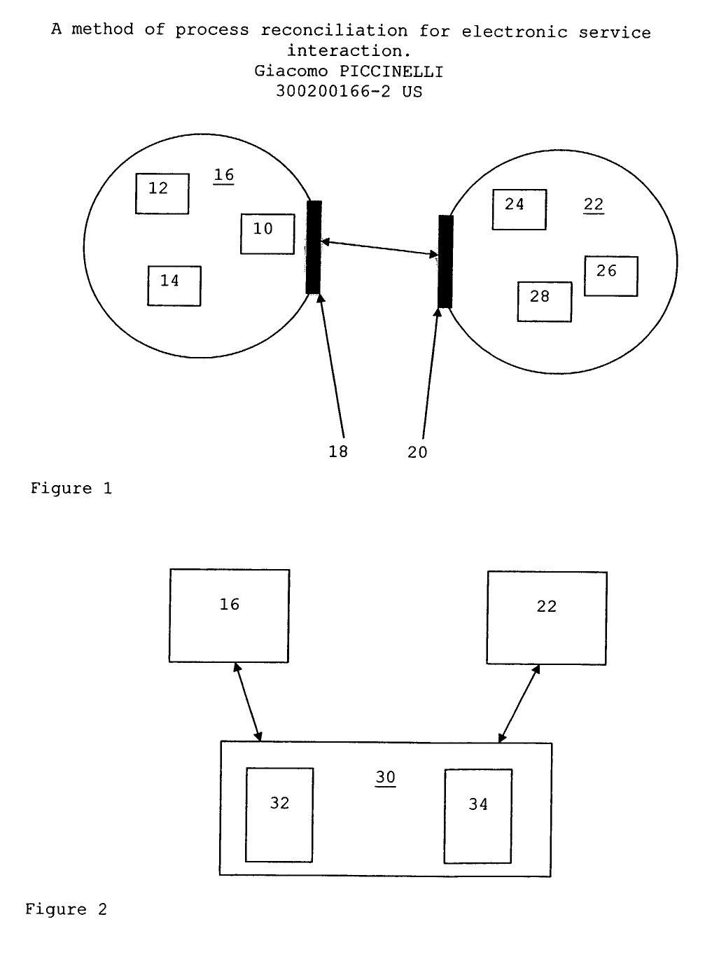

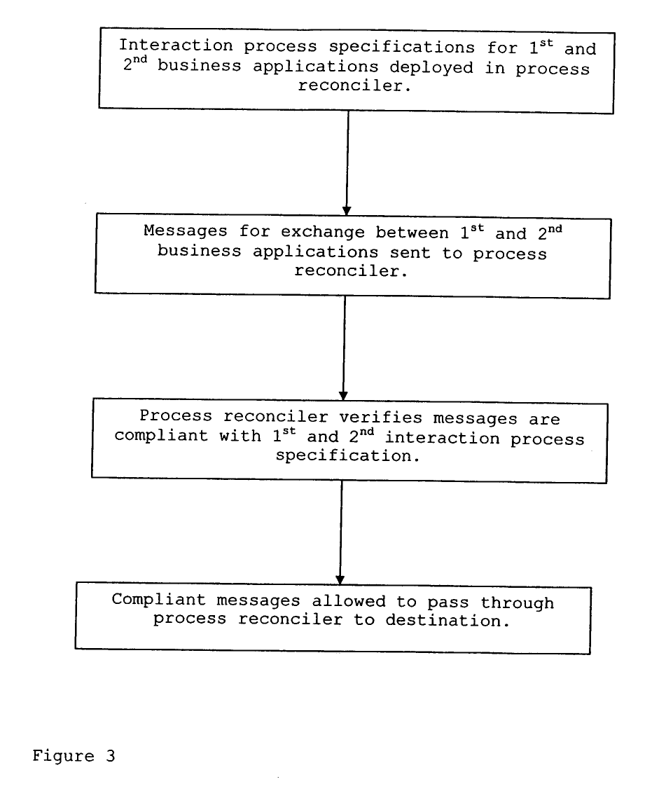

### DESCRIPTION OF PREFERRED EMBODIMENTS

A process reconciler 30 communicates with a first business application 16 and a second business application 22 in order to facilitate communication between the first and second business applications 16, 22.

Interaction process specifications 32, 34 of the first and second business applications respectively are deployed in the process reconciler 30. The process specifications may be defined, for example, in the WSFL or WSCL standards using the Process Definer component of the Hewlett Packard Process Manager product, more details of which can be found at www.ice.hp.com. The implementation may also be carried out using the XpML reference language.

The messages to be exchanged between the first business application 16 and the second business application 22 go through the process reconciler 30, which verifies that the message is compliant with the interaction process 32 of the sender, for example the first business application 16, then verifies that the message is compliant with the interaction process 34 of the receiver, for example the second business application 22. When a message is compliant with both interaction processes 32, 34 the message is allowed through the process reconciler 30. Similar procedures are used to handle incoming messages. Positive compliance implies the evolution of the state of the two business processes 32, 34.

The business processes 32, 34 described are of the type which are specified as comprising various expected inputs, outputs following from those inputs, together with decision points such as verification procedures and the like. A product such as Hewlett-Packard's Process Manager product can be used to specify such a business process using the Process Definer component, the business processes can then be run in HP Process Manager, in conjunction with the Process Manager application program interface (API).

The two interaction processes 32, 34, one from the first business application and the other from the second business application are both run on the same program at the same time in a step by step fashion and comparisons are made between the two. This allows a semantic comparison to be made between the two interaction processes, which comparison is less rigorous than a structural comparison which needs closer similarity in order to function. Thus, a pragmatic comparison is made. As an example, a step in an interaction process 32 may require the input of two variables such as a user identification number and an order number. This requirement for input will be passed to the process reconciler 30 for a comparison with the other interaction process 34. If the other business application 22 at that point supplies to its interaction process 34 the required user name and order number then, even if there are some technical differences between the two business processes, then semantic similarity will be achieved which will allow the comparison process to continue further.

The implementation of the invention is easily achieved using Hewlett-Packard's Process Manager with the use of the Process Definer component. The system allows the writing, deployment and instantiation of the two business processes, or more than two business processes if required. A simple Java application can use the Process Manager API for the routing of the messages and for the basic compatibility test.

If it occurs that the two processes are not compatible then an exception can be raised to allow more resolution of the problem. Such exceptions will be raised less often than in the prior art method, because of the pragmatic comparison that has been made.

In practice, implementation may be used to check compliance between the suggestions of the first business application owner and the second business application owner. Ordinarily, rigid compliance in a structural sense would be required. However, an implementation of this invention could be that the two processes are run together in the process reconciler 30 in order to see if the two processes are reasonably compatible with a view to the first and second business application owners entering a contract if reasonable compatibility can be achieved. Alternatively, if a contract has been signed between the first and second business application owners and one of the business processes was found to be incompatible with the other, then one of the parties could simply declare that the contract had been breached and seek some remedy. This would of course not fix the incompatibility between the two processes but would provide some possibility for resolution.

The method envisages that both the interaction processes for the first and second business applications will be published on a UDDI registry to advertise the services and to allow others to examine what interaction processes are required in order to comply with the wishes of that business application.

The method described herein and its implementation in the form of computer programs and then on computers advantageously provides a run time check on compliance between two business applications. The two applications must be compatible, but only in a semantic sense rather than a structural sense as would previously have been required. The implementation of the method is advantageously straight forward and overcomes the disadvantages associated with the prior art discussed above.

1. A method of testing compatibility of at least two electronic service interaction processes comprises:
running a first interaction process of a first computing platform and a second interaction process of a second computing platform in a process reconciler, in which each of the interaction processes is treated separately;
analysing input/output requirements for the first/second interaction process for compatibility with the second/first interaction process; and
passing input/output data between the first computing platform and the second computing platform via said process reconciler, on detecting said compatibility.

2. A method as claimed in claim 1, in which the first and second interaction processes are analysed for compatibility at substantially each stage where an output is given or an input is expected.

3. A method as claimed in claim 1, in which the first and second interaction processes are run substantially simultaneously whilst compatibility is found.

4. A method as claimed in claim 1, in which an exception is raised if compatibility is not found.

5. A method as claimed in claim 1, which tests compatibility between two interaction processes to a level of structural compatibility.

6. A method as claimed in claim 1, in which the analysis includes checking that at a given stage the expected output of one of the first and second interaction processes is the same as the expected input for the other of the first and second interaction processes.

7. A method as claimed in claim 1, in which the first and second interaction processes are world wide web interaction processes.

8. A method as claimed in claim 1, in which the first and second interaction processes are interaction processes for the sale/purchase of goods and/or services.

9. A method as claimed in claim 1, in which the process reconciler acts as an intermediary between the first and second computing platforms.

10. A method as claimed in claim 1, in which the process reconciler permits each of the first and second computing platforms to use its own interaction process, but still interact with the other computing platform.

11. A method as claimed in claim 1, in which the process reconciler is run by a third party independent from the first and second computing platform.

12. A method as claimed in claim 1, in which the process reconciler is run by one of the first and second computing platforms.

13. A computer programmed to test compatibility of at least two electronic service interaction processes by:
running a first interaction process of a first computing platform and a second interaction process of a second computing platform in a process reconciler, in which each of the interaction processes is treated separately;
analysing input/output requirements for the first/second interaction process for compatibility with the second/first interaction process; and
passing input/output data between the first computing platform and the second computing platform via said process reconciler, on detecting said compatibility.

14. A process reconciler operable to test compatibility of at least two electronic service interaction process by:
running a first interaction process of a first computing platform and a second interaction process of a second computing platform in a process reconciler, in which each of the interaction processes is treated separately;
analysing input/output requirements for the first/second interaction process for compatibility with the second/first interaction process; and
passing input/output data between the first computing platform and the second computing platform via said process reconciler, on detecting said compatibility.

15. A process reconciler as claimed in claim 14, which is stored on a recordable medium.

16. A recordable medium bearing a program operable to test compatibility of at least two electronic service interaction processes by:
running a first interaction process of a first computing platform and a second interaction process of a second computing platform in a process reconciler, in which each of the interaction processes is treated separately;
analysing input/output requirements for the first/second interaction process for compatibility with the second/first interaction process; and
passing input/output data between the first computing platform and the second computing platform via said process reconciler, on detecting said compatibility.
